(19) United States
(12) Patent Application Publication
(10) Pub. No.: US 2024/0228920 A1
(43) Pub. Date: Jul. 11, 2024

(54) Distilled Spirit with modified Alcohol Levels with or without a Functional Ingredient

(71) Applicant: Robert Brocia, Bronxville, NY (US)

(72) Inventor: Robert Brocia, Bronxville, NY (US)

(21) Appl. No.: 18/445,740

(22) Filed: Jan. 9, 2024

Related U.S. Application Data
(63) Continuation-in-part of application No. 63/576,044, filed on Jan. 9, 2023.

(51) Int. Cl. C12H 3/00; C12G 3/04

(52) U.S. Cl. CPC C12H 3/00; C12G 3/04

(57) ABSTRACT

Compositions containing inhibitors of monoamine oxidase A and monoamine oxidase B from distilled spirits, prepared by distillation from agave-derived sources with methods to selectively remove ethanol and/or MAO inhibitors are disclosed.

### CROSS-REFERENCE TO RELATED APPLICATIONS

This application claims priority to U.S. Provisional Application No. 63/576,044 filed Jan. 9, 2023, the contents of which are incorporated herein by reference in their entirety.

### BACKGROUND ART

U.S. Pat. No. 10,195,163 describes the production of compositions containing significant concentrations of inhibitors of MAO A and MAO B from tequilas and from pulque. Reverse osmosis and spinning cone column technologies are described as techniques for removing alcohol while preserving the activity of these inhibitors, as these inhibitors are volatile and may be formed during fermentation and distillation of tequila and fermentation of pulque. It is possible that these represent single MAO inhibitors or more than one, so singular and plural are used herein interchangeably.

U.S. Patent Application No. 2018/0296629 published 18 Oct. 2018 describes improved methods to remove alcohol from the distillates. The contents of this document are incorporated herein by reference, but briefly, methods that include reverse osmosis and low-pressure evaporation to provide retentates with significant concentrations of these inhibitors are described. In addition, details of assay methods for monoamine oxidase activity (and therefore inhibition thereof) and for ethanol content are provided.

U.S. patent application Ser. No. 16/696,898 filed Nov. 26, 2019, discloses the effect of MAO B inhibition on the consumers of tequila. The ratings, or number of “Likes,” mimic the percent inhibition of MAO B in different Don Julio brand tequilas. Conversely, when the brand's second highest rated tequila is further processed to a Crystalino tequila, a process that results in the lowest MAO B inhibitor levels, the ratings are in-step and fall to the lowest level of the five brand offerings.

U.S. Pat. No. 4,612,196 filed Aug. 23, 1984, discloses a low alcoholic beverage production method using reverse osmosis.

Recently, there have been introduced many brands of formulated non-alcoholic beverages that attempt to act as a replacement for their alcoholic counterparts. For example, the Ritual company produces distilled spirit-like products to replace tequila, whiskey, and others. However, the Ritual products are not truly distilled spirits or made from distilled spirits, but more a combination of flavor compounds.

Another product is produced by Seedlip, which is stated by the company to be a non-alcoholic distilled spirit. However, the Seedlip products are not attempting to recreate non-alcoholic version of a known distilled spirit, it is believed the company distils off the ethanol after performing ethanolic extractions on plant-based material and incorporate the extracts into a water-based beverage. There is apparently no fermentation-derived essence in the Seedlip products.

Although dealcoholized beer and wine are well known and commercially available, there does not appear to be any actual distilled spirit products available without alcohol. Beer, wine and kombucha are readily available without alcohol, however, the common theme seems to be the unavailability of fermented dealcoholized products in which the starting alcohol by volume (ABV) is greater than approximately 15%. The dealcoholization processes used in the industry include reverse osmosis (RO) and spinning cone column (SCC). Both have technical limitations that involve limits for the removal of ethanol. For example, wine and beer are relatively low in alcohol content (less than 20% ABV) and may be put through either process without dilution. Distilled spirits at or above 40% ABV cannot be processed at full strength by RO due to membrane/ethanol incompatibility. RO requires the spirit to be diluted below 20% ethanol ABV. High ethanol concentration will disrupt membrane integrity, but with dilution the resulting dealcoholized product would lose its original organoleptic qualities.

In the case of spinning cone column (SCC), using a feed source at high alcohol concentration produces explosive ethanol vapors that must be considered. SCC initially strips aroma compounds with ethanol, which must be separated through chromatographic methods.

There does not appear to be a non-alcoholic distilled spirit available with the characteristics and desirable qualities of the present invention. The present invention is derived from a fermented mash identical to the alcoholic counterpart, such as whiskey, rum, tequila, etc. at an ethanol by volume concentration equal to or above 40%. The present invention retains the original organoleptic qualities of the starting distilled spirit and provides the experiential effects from MAO inhibition with alcohol concentrations less than 40% by volume.

### DISCLOSURE OF THE INVENTION

In one aspect, the present invention is based on the recognition that the ratio of the inhibitors contained in agave derived distillates for inhibition of MAO B as compared to inhibition of MAO A is significant. It is now understood that the quality of either the distillate itself used as a beverage or of a derivative relatively nonalcoholic form thereof is at least in part determined by the ratio of inhibitors of monoamine oxidases A and B.

Thus, the invention is directed to a method to improve the quality of a beverage which is tequila or mezcal or a drink with reduced alcohol content derived therefrom which method comprises altering the ratio of inhibitor of MAO B to inhibitor of MAO A contained therein to increase this ratio in favor of MAO B inhibition.

In another aspect, the invention is directed to a method to create a low or non-alcoholic distilled spirit by a non-dilution process that retains volatile components other than ethanol.

In yet another aspect, the present invention is directed to a method to create a low or non-alcoholic distilled spirit by a non-dilution process that retains volatile components other than ethanol, in which the volume of ethanol removed is replaced by a volume of similarly dealcoholized agave-derived fermented spirit with a high ratio of MAO B to MAO A inhibition.

Thus, the invention is directed to a method to create a desirable dealcoholized distilled spirit by processing a greater than 20% ABV distilled spirit beverage without dilution by a method that removes ethanol while retaining other components comprising the flavor profile of the distilled spirit and providing a functional ingredient derived from dealcoholized fermented agave-based sources.

In another embodiment, the present invention is a dealcoholized distilled spirit created by processing a greater than 20% ABV distilled spirit beverage without dilution by a method that removes ethanol while retaining other components comprising the flavor profile of the distilled spirit and providing a functional ingredient of MAO inhibitory activity derived from dealcoholized fermented agave-based sources. The MAO inhibitory activity of which is of a MAO B to MAO A ratio that is greater than 1.

The present invention includes modification or maintenance of the organoleptic properties of a distilled spirit by retention of compounds. Beverages that are thus obtained and methods to treat depression and Parkinson's disease and to enhance cognition by providing these beverages are also part of the invention.

### BRIEF DESCRIPTION OF THE DRAWINGS

FIG. 1 depicts a distillation apparatus.

FIG. 2 illustrates a vacuum distillation system for reduced pressure operation.

FIG. 3 illustrates a vacuum distillation system with multiple condensers.

### MODES OF CARRYING OUT THE INVENTION

With respect to the first aspect of the invention, the quality of a beverage is improved by altering the ratio of inhibitor of MAO B to inhibitor of MAO A contained therein to increase this ratio in favor of B.

It is understood that MAO inhibitors are used to treat depression, inhibitors of MAO B are also used to treat Parkinson's disease. Increased MAO B activity is associated with aging and cognitive decline in humans. MAO B catalyzes the metabolism of phenylethylamine (2-phenylethylamine, PEA), a neurotransmitter classified as a trace amine with effects similar to amphetamine that is believed to increase the concentration of serotonin and dopamine in the synaptic cleft by inhibiting re-uptake of those neurotransmitters. Trace amines are present in significantly lower concentration than other functional amine neurotransmitters, but PEA has a potent effect by its mechanism of action that involves binding to a G protein coupled receptor of the type that is also activated by amphetamine. Metabolic breakdown of PEA is thus a depressant and hydrogen peroxide, a by-product resulting from MAO B activity, contributes to cognitive decline.

It is further understood that MAO B inhibition increases levels of phenylethylamine, which increases levels of serotonin and dopamine for positive experiential effects. Thus, enhanced levels of MAO B inhibitor provide the ability to improve cognition.

Thus, in one illustrative embodiment using the example of tequila, ethanol is removed to a desired level with simultaneous removal of MAO A inhibitors and retention of MAO B inhibitors resulting in an effective concentration and desired ratio of inhibitors MAO A/MAO B to produce the desired experiential effect for the user. A desirable experiential effect is mood elevation or a feeling of well-being, which is currently undefined with respect to tequila as that contains typically 40% ethanol by volume, masking the effects of MAO inhibitors. Although tequila has the same ethanol concentration as other distilled spirits, the experiential effect is noticeably different as confirmed by anecdotal information found online. For example, the description by the founders of celebrity tequila, Casamigos, includes this statement about formulating the brand “ . . . typically we drink it straight or on the rocks—that we could drink all day long and not be hungover in the morning.” The question becomes of why it can be consumed “all day long,” but not be followed by a hangover. This is due to the presence of MAO inhibitors, which Table 1 shows the ratings of Don Julio tequila correlate with MAO B inhibition. The converse is also true as indicated by the Don Julio 70^{th}, which is produced from the Añejo with a significant loss of MAO B inhibitory activity (26% inhibition down to 6%). Consequently, ‘likes’ fall from 141 to 70. Processing spoils the añejo tequila's ‘likability’ by decreasing MAO B inhibition.

TABLE 1

| | % Inhibition | % Inhibition | |
|---|---|---|---|
| Brand | MAO A | MAO B | Likes |
| Don Julio 1942 | 18 | 35 | 290 |
| Don Julio Añejo | 10 | 26 | 141 |
| Don Julio Reposado | 18 | 22 | 113 |
| Don Julio Blanco | 9 | 8 | 106 |
| Don Julio 70^{th} | 12 | 6 | 70 |

Table 1 provides a basis to suggested that the MAO inhibitors present in agave derived spirits are indeed bioactive. The inhibitor dependent “likes” are as would be expected with the prevention of metabolism of biogenic amines. The brains reward system associated with increased levels of dopamine appears to be a factor with consumer response to MAO B inhibition.

The invention is a method to create a low or non-alcoholic distilled spirit by a non-dilution process that retains volatile components other than ethanol. In the case of whiskey or other distilled spirit, conventional dealcoholization methods cannot provide an acceptable result, for in the case of reverse osmosis the spirit must be diluted to an ethanol concentration below approximately 20% or to a level that will not harm the semipermeable RO membrane. Similarly, spinning cone column methods require special consideration if the feed is at high ethanol concentration due to generation of explosive vapors. In addition, SCC methods strip flavor compounds along with ethanol.

A preferred method of alcohol removal according to the invention is by distillation alone, without consideration of distillate heads, tails, or hearts. The starting material already represents the desirable “heart” fraction because in the production of the distilled spirit the undesirable components have already been rejected. According to the invention, distillation is performed with either conventional distillation or fractional distillation at atmospheric or lower pressure. In general, the system will include a boiling flask to which is attached a column that includes contacting plates, such as bubble cap plates, in which vapor will travel up the column and liquid phase travels down back to the boiling flask. The number of plates will depend on the complexity of the components and ethanol concentration in the feed spirit. Discrete volatile compounds in the feed spirit may have boiling points at significantly higher temperatures than the temperature of the distillation, but vaporization of compounds will depend on the relationship the volatiles have with the matrix rather than their reported boiling point as a pure compound.

In a further embodiment of the invention, a drink containing MAO inhibitors is produced from a feedstock of a distilled agave-derived beverage at 40-60% ethanol by volume (ABV). The feed is treated with a deep eutectic solvent (DES) comprised of glycerol and choline chloride at a molar ratio of approximately 2:1. The DES breaks the azeotrope that normally is associated a mixture of ethanol and water, the alcohol/water azeotrope complicates separation of ethanol since it has a boiling point less than that of ethanol alone. In addition, it is unclear how the molecular interactions of other components present in agave spirits may influence volatilization of desired flavor compounds. It has been reported in the literature that a water/ethanol mixture may be resolved by breaking the azeotrope with certain conditions that include distillation under sub atmospheric pressures. After the alcoholic feed is treated with a DES, including glycerol/choline chloride, and added to the boiling flask of a distillation apparatus, evaporation of ethanol is possible.

It is also advantageous to proceed with the distillation of ethanol at a lower temperature than may be achieved without a DES as analysis of the MAOI profiles of distilled agave-derived spirits shows a decrease in MAO B inhibition related to distillation temperature and time. For example, Don Julio añejo tequila when converted to the 70th version undergoes a 3^{rd} distillation, which lowers MAO B inhibition. Also, in preparing samples of dealcoholized tequila we have noticed a loss of MAO B inhibitory activity when harsher conditions are used.

One preferred method to prepare a nonalcoholic beverage according to the invention is treating a 30-80% ABV spirit with a DES, such as choline chloride-glycerol at a molar ratio of 1:2. Depending upon the components comprising the spirit, a weight/weight amount of DES includes 1-15%. For some dealcoholizing steps a vacuum fractional distillation apparatus is used with pressures from 90 to 760 Torr. Temperature at the boiling flask will be adjusted according to pressure where boiling for ethanol vaporization may occur above atmospheric pressure and volatilization of desired flavor compounds is reduced.

Some known MAO inhibitors are non-specific or cross-react with both MAO A and B, however, the inhibitors present in tequila are specific inhibitors for either form of monoamine oxidase. This is seen in the activity assay results comparing Don Julio Añejo (DJA) and Casa Dragones (CD) brands.

### Example 1

Don Julio Añejo tequila (DJA) 5 L was diluted to 40 L and concentrated back to 5 L (batch mode) in an Alfa Laval M20 RO processor, followed by further recirculating with the volume maintained at 5 L (diafiltration mode) until the ethanol concentration was lowered to ˜1.3% ABV. The RO processor was equipped with a 90% NaCl rejection membrane (RO90).

For comparison, DJA was processed under the same conditions except with a 95% NaCl rejection membrane, a 99% NaCl rejection membrane and a nanofiltration (NF) membrane.

Table 2 shows MAO inhibitory activity in the resulting RO concentrates from the four membranes. The membranes effectively maintain the MAO B inhibitor concentration but reduce the MAO A inhibitor concentration providing an improved final product through retention of MAO B inhibitors. The nanofiltration membrane (NF) reflects a standard of comparison for alcohol removal per se.

TABLE 2

| | MAO A | MAO B | B:A |
|---|---|---|---|
| Membrane | % inhibition | % inhibition | inhibition |
| 90% NaCl Rejection RO | 11 | 43 | 4 |
| 95% NaCl Rejection RO | 20 | 40 | 2 |
| 99% NaCl Rejection RO | 5 | 30 | 6 |
| NF | 17 | 25 | 1.2 |

### Example 2

Solvent extracts of two tequilas were made as follows: Tequila (300 ml) was diluted to 600 ml with deionized water and extracted with dichloromethane (3×125 ml). The extracts were combined and passed over a column of anhydrous sodium sulfate. Solvent was removed by evaporation in a Kuderna Danish apparatus warmed over a water bath at 70° ° C. Don Julio Añejo (DJA) and Casa Dragones Blanco (CD), were partially purified by silica gel chromatography run with 95% dichloromethane/5% methanol. Fractions (300 μL) were collected and each was assayed for MAO A and MAO B inhibitory activity. The fractions with inhibitory activity were further fractionated by HPLC and active fractions were analyzed by mass spectrometry.

### Example 3

The effect of compounds on MAOI activity in tequila was evaluated in the experiment from Table 3. Compounds were added to 40% ethanol and tequila (40% ABV) at 0.5% (v/v) and assayed for MAO inhibitory activity.

TABLE 3
Don Julio Añejo (DJA) or 40% ethanol (ETOH) were spiked
with terpenes and assayed for MAO A and MAO B inhibitory activity.

| Δ % Inhibition MAO A | | Δ % Inhibition MAO B |
|---|---|---|
| (DJA + terpene) − | | (DJA + terpene) − |
| (ETOH + terpene) | Terpene | (ETOH + terpene) |
| 1 | eugenol | 8 |
| 0 | citral | 2 |
| 4 | Geramol | 9 |
| 1 | terpinolene | 9 |
| 7 | terpineol | 18 |
| 5 | β-myrcene | 11 |
| 9 | valencene | 20 |
| 8 | limonene | 10 |

Dealcoholized tequila is a novel, specific and reversible MAO inhibitor with usefulness as a functional ingredient for food and beverage. Following dealcoholization, the MAO inhibitor may be added to a cola drink, for example, at 50 ml to 250 ml cola. The collection of compounds in table 3 are used as synergistic ingredients to the MAOIs when it is used as a functional ingredient.

For example, a cola drink, as an enhanced beverage will contain compounds chosen from Table 3 in addition to the agave derived functional ingredient. The compounds are added to 1 liter of MAO fortified beverage at an amount of 0.1-40 mg of compound.

The experiential effect of mood elevation is achieved with a MAO B-to-MAO A inhibition ratio of greater than 1. A formulation for agave derived beverages that provides enhanced MAO B inhibition is prepared by adding one or more compounds from Table 3 at 0.1-40 mg per liter of beverage.

### Example 4

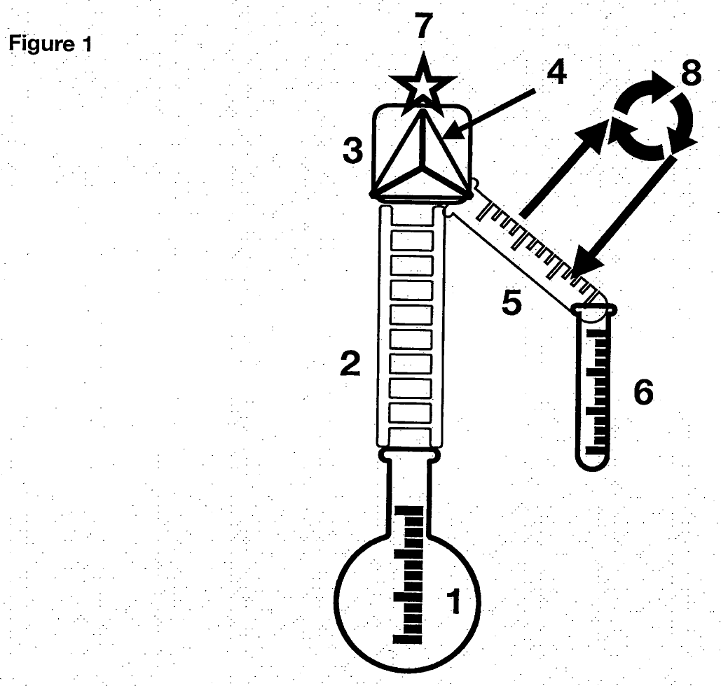

In another embodiment, dealcoholization is accomplished with a source comprised of a fermented mash from an agave-derived sugars that undergoes two distillations (i.e., tequila, according to the Mexican CRT for tequila; or following other traditional methods developed for bacanora, sotol or mezcal) the resulting distillates from the second distillation are approximately 55% ABV or alternatively adjusted to approximately 40% ABV, as in the bottled distilled spirit. Distilled agave spirit is provided in bulk quantities from distillers at 55% ABV and bottled spirits are typically supplied at 40% ABV. Each provides a good source of agave-derived functional compounds with MAO inhibitory activity in ethanol/water solution. To remove ethanol while preserving the flavor and functional compounds, the agave spirit is added to boiling flask 1 of the distillation system (FIG. 1). The system is fitted with column 2, that includes vapor/liquid contactors (i.e., bubble plates, raschig rings or glass beads) or a vigreux or snyder column, with a reflux apparatus 3, and valve 4 at the top of the column. Distillation is begun by heating the boiling flask to obtain a state of reflux with vapor traveling up through the column plates, packing or baffles and liquid returning to the boiling flask of the system. It is important to use stainless steel contactors in the column. Conventional distillation systems for producing distilled spirits use copper somewhere in the system to remove undesirable components normally present as a product of fermentation. The copper in the boiler or column of the distillation system may produce toxic salt that will be dissolved in the aqueous phase or distillation bottoms. The system is provided with a temperature sensor at the top of the column to monitor fluctuations in temperature that signal collection of the distillate.

Once vapor/liquid reflux is established the valve is opened to direct the vapor to a cooled condenser 5, cooled by a recirculating refrigerated bath and the condensed vapor becomes liquid to the collection vessel 6 for fraction #1, after a drop in temperature the next fraction is recovered at a higher temperature as fraction #2. The next fraction is predominately the azeotrope of ethanol and water, which is collected as fraction #3, and remaining in the boiler is water with less volatile compounds.

At atmospheric pressure the boiling flask temperature is kept below 110° C. At reduced pressure, such as 60 Torr, the azeotrope of ethanol and water boils at room temperature and distillation is stopped to prevent water from distilling at the highest temperature. Depending upon the alcohol content desired fraction #1 may be added back to the boiling flask.

### Example 5

Another useful application of the invention that recognizes the importance of a ratio high in levels of MAO B inhibition relative to MAO A inhibition, is the production of a high MAO B inhibition tequila according to the following method:
a) The agave material comprised of complex sugars is turned into a slurry by a diffuser (equipment known in the industry) and acid hydrolysis is performed with sulfuric acid followed by thermal hydrolysis in an autoclave.

In contrast, traditional methods of hydrolysis involve thermal treatment of complex sugars in an oven, in which it is believed a multitude of reactions occur, including the formation of Maillard compounds.
d) The simple sugars are fermented in line with traditional methods.
e) Distillation is performed on a fractionating column ×2.

The production of a high MAO B tequila according to the invention involves chemical hydrolysis of the complex sugars followed by distillation according to the description in Mexican CRT for tequila.

### Example 6

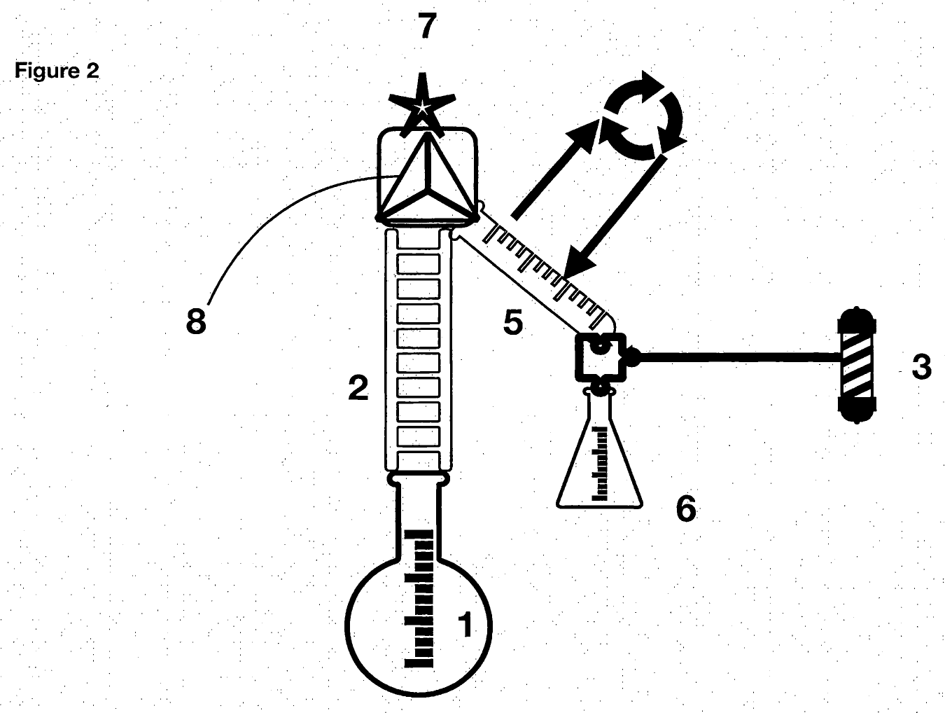

In yet another embodiment, isolation of MAO inhibitors is accomplished starting with a source of fermented agave-derived sugars, in the case of Pulque, or that undergoes two distillations (i.e., tequila, according to the Mexican CRT for tequila; or following other traditional methods developed for bacanora, sotol or mezcal) the resulting distillates from the second distillation are approximately 55% ABV or alternatively adjusted to approximately 40% ABV, as in the bottled distilled spirit. Distilled agave spirit is provided in bulk quantities from distillers at 55% ABV and bottled spirits are typically supplied at 40% ABV. Each, distillates (or undistilled in the case of pulque), provides a good source of agave-derived functional compounds with MAO inhibitory activity in ethanol/water solution. To remove ethanol while preserving the flavor and functional compounds, the MAOI source is added to a boiling flask 1 of the distillation system (FIG. 2). The system is fitted with column 2, with non-copper vapor/liquid contactors, vacuum pump 3 and vapor condensing means, which includes cooling means to liquify volatile compounds in the distillate. Distillation is begun by lowering the pressure of the system causing the most volatile components of the mixture in the boiling flask to boil and evaporate until the vapor encounters the condenser at a temperature low enough to liquify the volatile. The system is provided with a temperature sensor 7 at the top of the column to monitor fluctuations in temperature that signal the presence of different components at various vapor temperatures and for collection of the distillates.

Alternatively, distillation is started by warming the boiling flask to 40° C. and lowering the vacuum from atmospheric pressure to 175 mbar. This may be done incrementally or according to a programmable controller. Pure ethanol boils at 40° C. @ 175 mbar and its isolation is complicated by azeotropic behavior when mixed with water. Removal of ethanol is challenging working with a source of agave spirit due to azeotropes formed with water/ethanol and other components. Distillate is captured in the system by one or more condensers operating at low and very low temperature. This is somewhat different than reflux over column packing and capture as fractions of different volatility are exchanged from liquid vapor contactors to the top of the column and liquify at the condenser. The system is started by heating the boiling flask to obtain a state of reflux with or without column internal contactors with vapor traveling up through the column plates, packing or baffles and liquid returning to the boiling flask of the system.

With vapor/liquid reflux established a valve at the top of the column is partially opened to allow some of the vapor to migrate to the cooled condenser 4 and collection vessel 8 for fraction #1, after a drop in temperature the next fraction is recovered at a higher temperature as fraction #2. The next fraction is predominately the azeotrope of ethanol and water, which is collected as fraction #3, and remaining in the boiler is water with less volatile compounds.

At atmospheric pressure the boiling flask temperature is kept below 110° C. At reduced pressure, such as 60 Torr, the azeotrope of ethanol and water boils at room temperature and distillation is stopped to prevent water from distilling at the highest temperature. Depending upon the alcohol content desired fraction #1 may be added back to the boiling flask.

With vapor/liquid reflux established the valve is opened to direct the vapor to cooled condenser 5 and collection vessel 6 for fraction #1, after a drop in temperature the next fraction is recovered at a higher temperature as fraction #2. The next fraction is predominately the azeotrope of ethanol and water, which is collected as fraction #3, and remaining in the boiler is water with less volatile compounds. At atmospheric pressure the boiling flask temperature is kept below 110° C. At reduced pressure, such as 60 Torr, the azeotrope of ethanol and water boils at room temperature and distillation is stopped to prevent water from distilling at the highest temperature. Depending upon the alcohol content or flavor desired fractions may be added back to the boiling flask. Vacuum in the system is maintained at 80 mbar by a vacuum pump operating through a switchable three-way arrangement of cold traps similar to that seen in FIG. 2. The condensers were cooled to −25° C.

### Example 7

An effective method to isolate MAO inhibitors while simultaneously removing alcohol from agave derived fermented source material involves distillation in a sealed system under low pressure in which a column 12″×1″ packed with 6×6 mm rasching rings with an 800 ml boiling flask attached charged with agave spirit (70/30 agave sugar to corn sugar ferment) at 40-55% ABV. The system includes a condenser with coolant circulating at ˜2° C. attached to the top of the distillation column. The boiling flask is immersed in a water bath heated to 55-60° C. and the pressure is reduced to 900 mbar, then 800 mbar and finally to 175 mbar. This is the pressure at which ethanol boils at 40° C. and a reflux is noticed occurring within the column packing and a distillate appears condensing in the condenser and collecting in a collection flask attached to the condenser.

The reduced alcohol remainder in the boiling flask following analysis resulted in the following drink examples in Table 4.

TABLE 4

| % ABV | | | | | | | | |
|---|---|---|---|---|---|---|---|---|
| after | % Inhibition | % Inhibition | | Amount | | Boiler | Vacuum | Starting |
| distillation | MAO A | MAO B | Packing | in boiler | | (° C.) | (mbar) | % ABV |
| 29 | 0 | 15 | Rash Ring | 100 | g | 52 | 210-190 | 55 |
| 32 | −2 | 13 | Rash Ring | 50 | g | 55 | 175 | 55 |
| 6 | 12 | 15 | Rash Ring | 50 | ML | 55-60 | 210 | 40 |

### Example 8

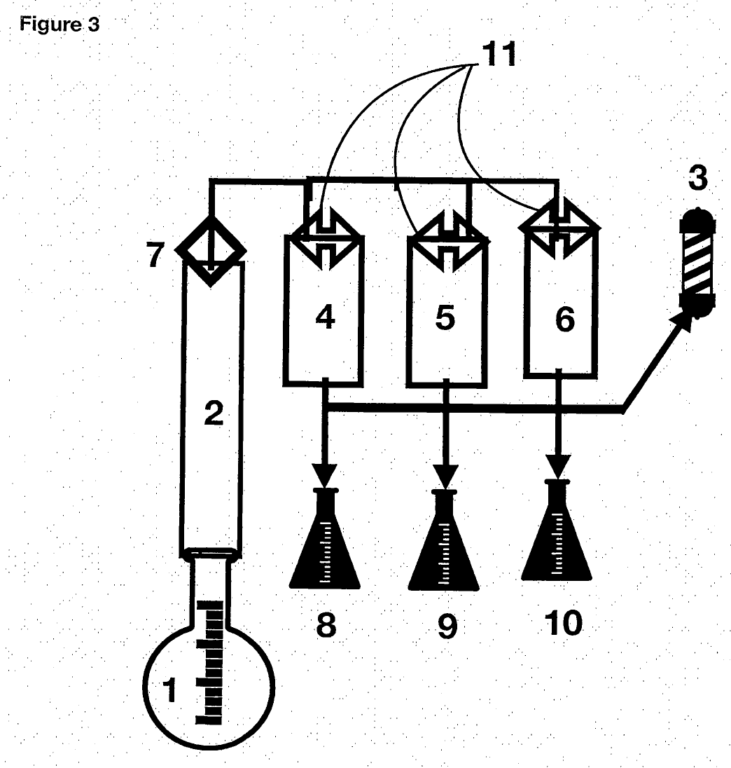

In yet another embodiment, removal of MAO inhibitors is accomplished starting with a source of fermented agave-derived sugars, in the case of Pulque, or that undergoes two distillations (i.e., tequila, according to the Mexican CRT for tequila; or following other traditional methods developed for bacanora, sotol or mezcal) the resulting distillates from the second distillation are approximately 55% ABV or alternatively adjusted to approximately 40% ABV, as in the bottled distilled spirit. Distilled agave spirit is provided in bulk quantities from distillers at 55% ABV and bottled spirits are typically supplied at 40% ABV. Each, distillates (or undistilled in the case of pulque), provides a good source of agave-derived functional compounds with MAO inhibitory activity in ethanol/water solution. To remove ethanol and the functional compounds that inhibit MAOs, while preserving the flavor, the MAOI source is added to a boiling flask 1 of the distillation system (FIG. 3). The system is fitted with column 2, without vapor/liquid contactors, vacuum pump 3 and several vapor condensing means, 4, 5 and 6 which includes cooling means 11, to liquify volatile compounds in the distillate. Distillation is begun by lowering the pressure of the system causing the most volatile components of the mixture in the boiling flask to boil and evaporate until the vapor encounters one of the condensers at a temperature low enough to liquify the volatile. The system is provided with a temperature sensor 7 at the top of the column to monitor fluctuations in temperature that signal the presence of different components at various vapor temperatures and for collection of the distillates.

Alternatively, distillation is started by warming the boiling flask to 40° C. and lowering the vacuum from atmospheric pressure to 175 mbar. This may be done incrementally or according to a programmable controller. Pure ethanol boils at 40° C. @ 175 mbar and its isolation is complicated by azeotropic behavior when mixed with water. Removal of ethanol is challenging working with a source of agave spirit due to azeotropes formed with water/ethanol and other components. Distillate is captured in the system by one or more condensers operating at low and very low temperature. This is somewhat different than reflux over column packing and capture as fractions of different volatility are exchanged from liquid vapor contactors to the top of the column and liquify at the condenser. The system is started by heating the boiling flask to obtain a state of reflux without column internal contactors, essentially the system is running with one theoretical plate. Vapor travels up through the column and some liquid returning to the boiling flask of the system. The system is provided with a temperature sensor at the top of the column to monitor fluctuations in temperature that signal collection of the distillate.

The vapor is directed to refrigerant-cooled condensers 4, 5 and 6 and cooled collection vessels 8, 9 and 10 for fractions collected. At reduced pressure, such as 60 Torr, the azeotrope of ethanol and water boils at room temperature and distillation is stopped to prevent water from distilling at the highest temperature. Depending upon the alcohol content desired fractions may be added back to the boiling flask.

The aqueous phase remaining in the boiler will be agave spirit with reduced alcohol content without MAO inhibitors. Of course, the MAO inhibitors that are collected may be added back to the aqueous fraction remaining.

1. A method to improve consumer ratings of tequila or mezcal or a drink with an ethanol content less than 40% by volume derived therefrom, which method comprises altering the level of inhibitory activity of monoamine oxidase A or monoamine oxidase B contained therein, wherein altering comprises the addition of one or more compounds without monoamine oxidase inhibitory activity.

2. A method to improve consumer ratings of tequila or mezcal or a drink with an ethanol content less than 40% by volume derived therefrom, which method comprises altering the level of inhibitory activity of monoamine oxidase A or monoamine oxidase B contained therein, wherein altering comprises the addition of one or more of the following compounds: eugenol, citral, geramol, terpinolene, terpineol, β-myrcene, valencene, limonene.

3. A method to create a distillate with monoamine oxidase B (MAO B) inhibitory activity, which method comprises distillation of a fermented mash resulting from chemical hydrolysis of complex sugars derived from agave.

4. A method to create a distillate with monoamine oxidase inhibitory activity, which method comprises distillation of a fermented mash produced by non-thermal hydrolysis of complex sugars derived from agave.

5. A method to lower the ethanol concentration in a distilled spirit, while retaining inhibitors of monoamine oxidase contained therein, comprising a process of distillation in which said process is performed without regard to head, hearts, and tails.

6. A method to lower the ethanol concentration in a distilled spirit, while retaining inhibitors of monoamine oxidase contained therein, comprising a process of distillation in which said process is performed without copper components.

7. The method according to claim 6 in which the process is performed at or below atmospheric pressure.

8. A method to create an agave-derived distilled spirit by a process that retains volatile components other than ethanol, in which the volume of ethanol removed is replaced by a volume of similarly processed agave-derived fermented spirit with a high ratio of MAO B to MAO A inhibition.

9. A method to lower the ethanol concentration in a distilled spirit and reduce the level inhibitors of monoamine oxidase contained therein, comprising a process that includes several distillations at atmospheric pressure in which said process includes collection of the retained fraction from said distillations.

10. A method to lower the ethanol concentration in a distilled spirit and reduce the level inhibitors of monoamine oxidase contained therein, comprising a process that includes distillation at below atmospheric pressure in which said process includes a column with one theoretical plate.
